(19) United States
(12) Patent Application Publication
(10) Pub. No.: US 2020/0313314 A1
(43) Pub. Date: Oct. 1, 2020

(54) COUPLERS FOR PHOTOVOLTAIC SYSTEMS

(71) Applicant: Matthew Robertson, Eugene, OR (US)

(72) Inventor: Matthew Robertson, Eugene, OR (US)

(21) Appl. No.: 16/832,936

(22) Filed: Mar. 27, 2020

Related U.S. Application Data
(60) Provisional application No. 62/824,441, filed on Mar. 27, 2019.

(51) Int. Cl. H01R 4/40; H02S 20/20; H02S 40/30; H01R 4/26

(52) U.S. Cl. CPC H01R 4/40; H02S 20/20; H01R 4/64; H01R 4/26; H02S 40/30

(57) ABSTRACT

Couplers including a body, a link shaft, and an arm. The body is complementarily configured with an interface portion of a rail to selectively interlock with the interface portion and is configured to electrically couple to the interface portion. The link shaft is moveably coupled to the body. The arm is mounted to the link shaft. The arm is configured to selectively abut the frame of the solar panel and to electrically couple to the frame. In certain examples, the coupler includes a threaded collar. In some examples, the coupler includes a rocker shaft movably coupled to the body and confiunred to move the arm.

### CROSS REFERENCE TO RELATED APPLICATIONS

This application claims priority to copending U.S. Application, Ser. No. 62/824,441, filed on Mar. 27, 2019, which is hereby incorporated by reference for all purposes.

### BACKGROUND

The present disclosure relates generally to couplers for photovoltaic systems. In particular, couplers for securing solar panels to rails and providing an electrically conductive path between solar panels and rails are described.

Photovoltaic systems are an emerging and increasingly important means for generating electricity without use of fossil fuels. Photovoltaic systems typically include an array of solar panels mounted to support rails with accompanying electrical means for harnessing the electricity generated by the solar panels. Fasteners and couplers are typically used to mount the solar panels to the rails.

The most common type of photovoltaic system has been rooftop solar panel arrays, which are typically mounted only a short distance above the roof. Hardware and installation methods for installing rooftop solar panel arrays are fairly well developed.

Increasingly popular photovoltaic systems are building-integrated photovoltaic systems and solar carports, which typically involve mounting solar panels a significant distance above the ground to provide space for people and vehicles underneath them. Installing building-integrated photovoltaic systems and solar carports presents unique challenges. For example, the solar panels being elevated above the ground or floor (rather than just a short distance above a roof) means that installers must in turn position themselves high above the ground utilizing ladders, lifts, or the like to install the panels.

Conventional hardware for installing solar panels exacerbates the challenges of installing building-integrated photovoltaic systems and solar carports. For example, conventional hardware is designed to be manipulated from above the solar panels, which works well enough for rooftop installations, but is awkward for building-integrated photovoltaic systems and solar carports. For building-integrated photovoltaic systems and solar carports, it would be more convenient and efficient to couple solar panels to support rails with hardware configured to operate from a position below the solar panels.

Another limitation of existing solar panel couplers is that they can not be easily accessed when they are located at interior positions of a solar panel array, such as when an interior panel needs to be repaired or replaced. After a solar panel array is assembled with conventional couplers designed to be accessed from above the panels, there is no effective way to reach couplers that are not located along the periphery of the array. Walking on the solar panel array to move closer to the interior coupler would be dangerous and would likely damage the solar panels. As a result, one must remove panels from the outside and continue to remove panels inwards to reach the desired panel, which is labor intensive and inefficient.

A further limitation of known couplers is that their shape limits their use to specific panel and rail coupling geometries. Expressed another way, conventional couplers can not be used to interchangeably secure solar panels to support rails at different panel positions because the shape of conventional couplers will interface with the panel and rail properly from only one orientation relative to the panel.

Another known limitation of conventional couplers relates to the means by which they seek to electrically bond the solar panel to the rail. Some existing couplers fail to adequately create an electrically conductive path. Other couplers will create an adequate conductive path, but are difficult and inconvenient to use. Still other couplers have overly complicated mechanisms to electrically bond solar panels to support rails, which makes them more expensive and less reliable.

Thus, there exists a need for couplers that improve upon and advance the design of known couplers for photovoltaic systems. Examples of new and useful couplers relevant to the needs existing in the field are discussed below.

Disclosure addressing one or more of the identified existing needs is provided in the detailed description below. Examples of references relevant to couplers for photovoltaic systems include U.S. Patent References: US20140102517A1; US20160285408A1; US20140010616A1; US20150311606A1; US20150101997A1; US20060257229A1; and U.S. Pat. No. 8,181,926. The complete disclosure of the above patents and patent applications are herein incorporated by reference for all purposes.

### SUMMARY

The present disclosure is directed to couplers including a body, a link shaft, and an arm. The body is complementarily configured with an interface portion of a rail to selectively interlock with the interface portion and is configured to electrically couple to the interface portion. The link shaft is moveably coupled to the body. The arm is mounted to the link shaft. The arm is configured to selectively abut the frame of the solar panel and to electrically couple to the frame. In certain examples, the coupler includes a threaded collar. In some examples, the coupler includes a rocker shaft movably coupled to the body and configured to move the arm.

### BRIEF DESCRIPTION OF THE DRAWINGS

FIG. 1 is a side perspective view of a first example of a coupler coupling a solar panel frame to a rail.

FIG. 2 is an end perspective view of the coupler shown in FIG. 1 coupling a solar panel frame to a rail.

FIG. 3 is a to side perspective view of the coupler shown FIG. 1.

FIG. 4 is a side perspective view of the coupler shown in FIG. 1.

FIG. 5 is a front elevation view of the coupler shown in FIG. 1.

FIG. 6 is a top plan view of the coupler shown in FIG. 1.

FIG. 7 is a bottom view of the coupler shown in FIG. 1.

FIG. 8 is a perspective view of a second example of a coupler coupling a solar panel frame to a rail.

FIG. 9 is a side perspective view of the coupler shown in FIG. 8.

FIG. 10 is a side elevation view of the coupler shown in FIG. 8.

FIG. 11 is a front elevation view of the coupler shown in FIG. 8.

FIG. 12 is a top plan view of the coupler shown in FIG. 8.

FIG. 13 is a bottom view of the coupler shown in FIG. 8.

### DETAILED DESCRIPTION

The disclosed couplers will become better understood through review of the following detailed description in conjunction with the figures. The detailed description and figures provide merely examples of the various inventions described herein. Those skilled in the art will understand that the disclosed examples may be varied, modified and altered without departing from the scope of the inventions described herein. Many variations are contemplated for different applications and design considerations; however, for the sake of brevity each and every contemplated variation is not individually described in the following detailed description.

Throughout the following detailed description, examples of various couplers are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature, in any given figure or example.

Definitions

The following definitions apply herein, unless otherwise indicated.

“Substantially” means to be more-or-less conforming to the particular dimension, range, shape, concept, or other aspect modified by the term, such that a feature or component need not conform exactly. For example, a “substantially cylindrical” object means that the object resembles a cylinder, but may have one or more deviations from a true cylinder.

“Comprising,” “including,”and “having” (and conjugations thereof) are used interchangeably to mean including but not necessarily limited to, and are open-ended terms not intended to exclude additional elements or method steps not expressly recited.

Terms such as “first”, “second”, and “third” are used to distinguish or identify various members of a group, or the like, and are not intended to denote a serial, chronological, or numerical limitation.

“Coupled” means connected, either permanently or releasably, whether directly or indirectly through intervening components.

Couplers for Photovoltaic Systems

With reference to the figures, couplers for photovoltaic systems will now be described. The couplers discussed herein function to mechanically and electrically couple a solar panel to a support rail. As will be readily apparent to the reader, the couplers enable selectively decoupling solar panels from support rails as well. The couplers further function to provide an electrically conductive path between the solar panel and the support rail.

The reader will appreciate from the figures and description below that the presently disclosed couplers address many of the shortcomings of conventional couplers. For example, the presently described couplers are configured to be used underneath solar panels instead of above them, which is much more convenient, efficient, and safe for building-integrated photovoltaic systems and solar carports. The couplers described herein avoid difficult and inefficient installation and maintenance techniques using conventional photovoltaic system hardware.

The presently described couplers improve over conventional couplers by enabling maintenance personal to readily access and manipulate them regardless whether they are located at the periphery of a solar array or at an interior position. Instead of needing to walk over the surface of the panels or needing to remove panels from the periphery inwards until a desired panel is exposed, maintenance personal can simply decouple an interior panel in an array by accessing the coupler securing the desired panel from beneath the array. The labor cost savings and convenience of being able to simply remove a desired panel instead of multiple panels is significant.

A further benefit of the currently described couplers is that they may be used at different positions on a panel interchangeably. Unlike conventional couplers for solar panels that are specific to one particulair orientation or panel-rail geometry, the presently described couplers can be used in corners of a panel simply by rotating the coupler.

The couplers described herein improve over conventional couplers by the simple and effective way they form an electrically conductive path from the solar panel to the rail. By providing a reliable, convenient, and inexpensive way to electrically bond a solar panel to a support rail, the presently described couplers help photovoltaic system installers comply with electrical codes and requirements with less hassle and redundancy than is possible with conventional couplers.

Contextual Details

The features of items used in conjunction with the couplers described herein will first be described to provide context and to aid the discussion of the couplers.

PhotovoltaicSystem

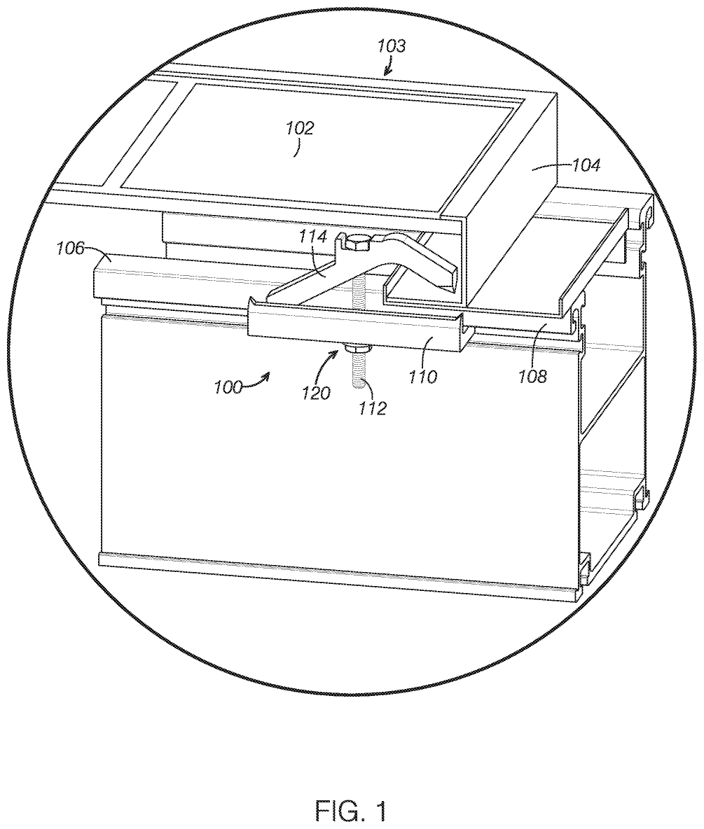

Photovoltaic system 101 functions to generate electricity from solar radiation. With reference to FIGS. 1, 2, and 8, the reader can see that photovoltaic system 101 includes a solar panel 102, a frame 104, and a rail 106. The couplers described herein may be used with any currently known or later developed type of photovoltaic system beyond the systems shown and described n this document.

As shown in FIGS. 1, 2, and 8, solar panel 102 is mounted on frame 104 to define a solar frame unit 103, Solar frame unit 103 is coupled to a rail 106 with couplers described herein, such as coupler 100 and coupler 200. Rail 106 has an interface portion 108. Interface portion 108 is complementarily configured with the couplers described herein to selectively interlock with the couplers.

Coupler Embodiment One

With reference to Figs, 1-7, a first example of a coupler, coupler 100, will now be described. Coupler 100 functions to mechanically and electrically couple solar frame unit 103 to a rail 106. Further, coupler 100 functions to selectively decouple solar frame unit 103 from rail 106. Coupler 100 also provides an electrically conductive path between solar frame unit 103 and rail 106.

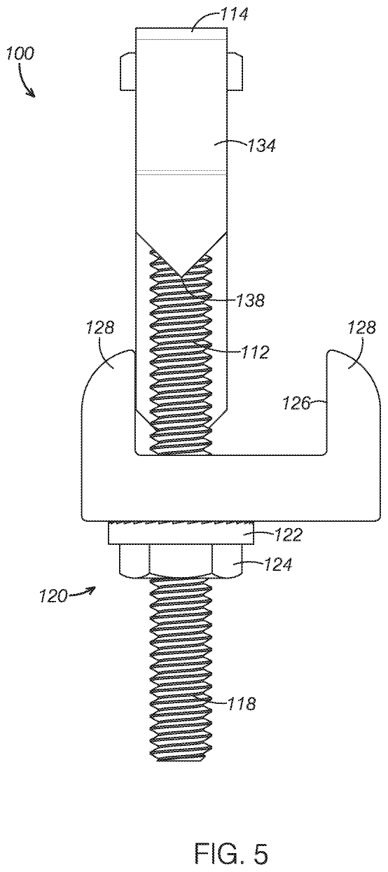

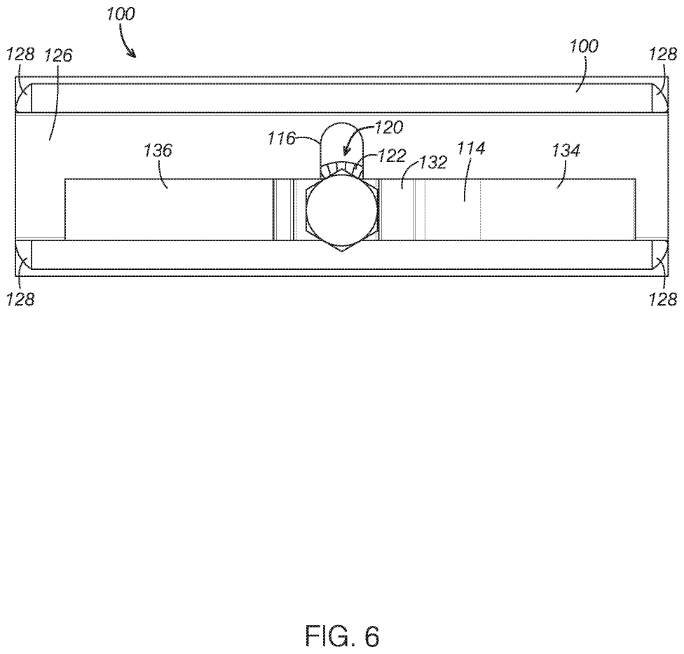

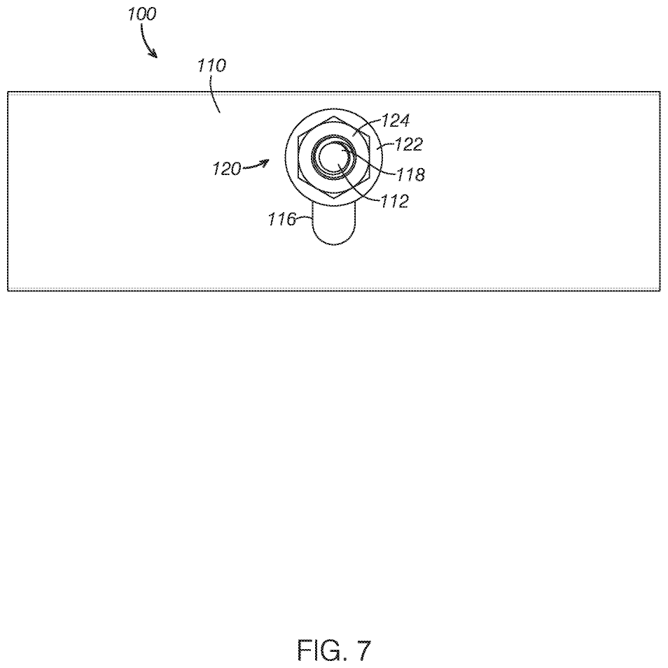

As shown in FIGS. 1-7, coupler 100 includes a body 110, a link shaft 112, an arm 114, and a threaded collar 120. In the present example, the components of the coupler are formed from metal, but they may be formed from any suitable material or combination of materials presently known or later developed.

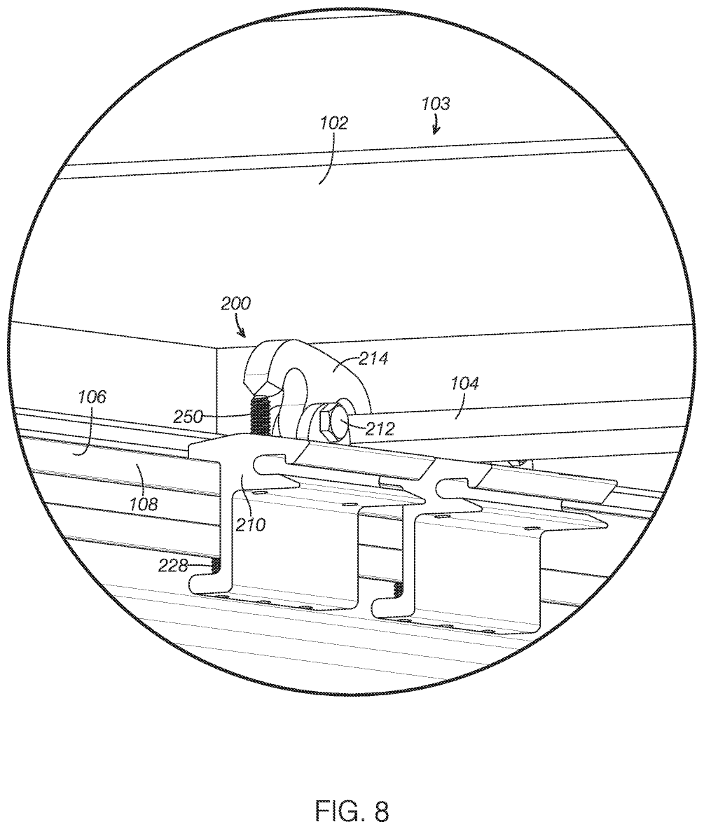

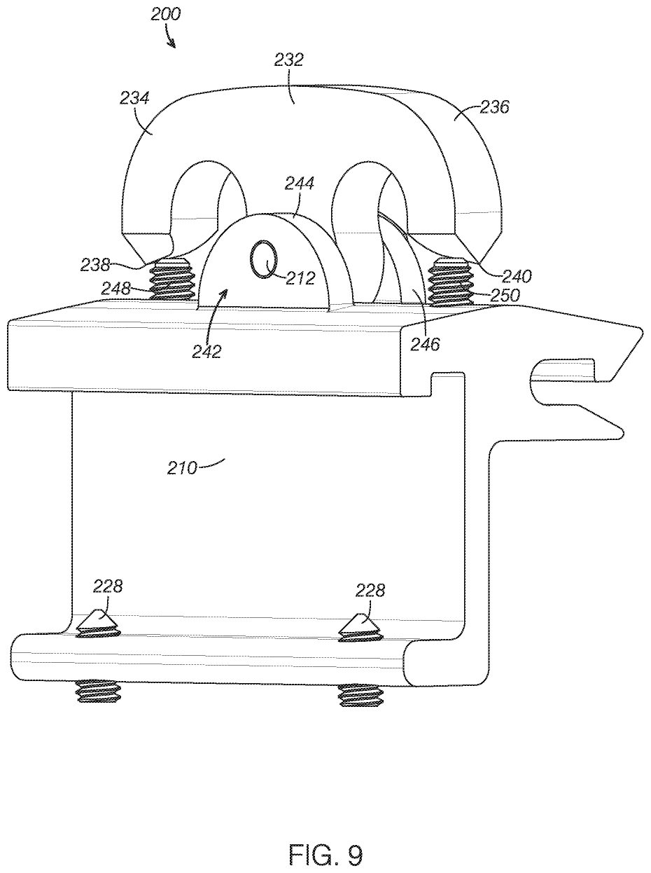

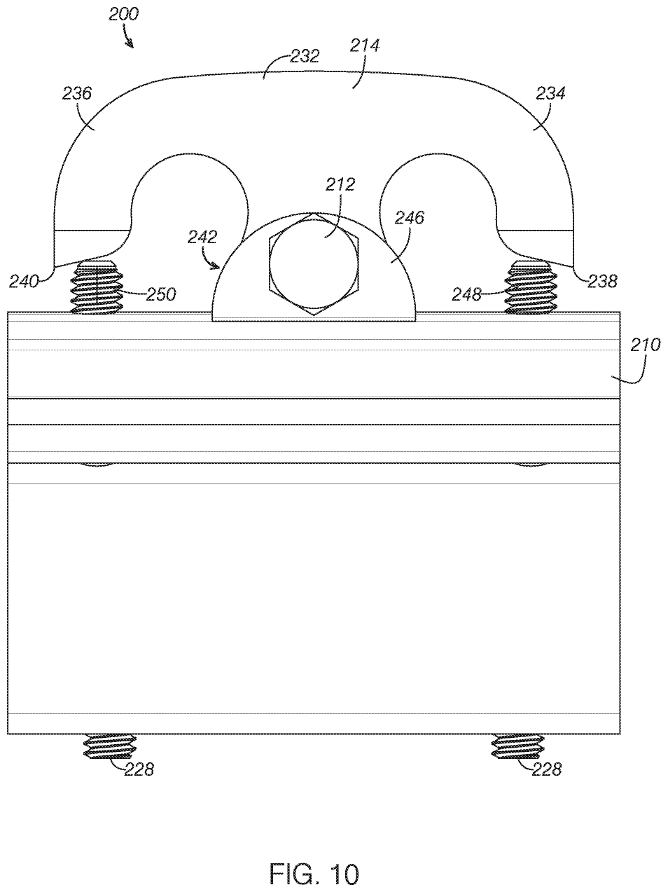

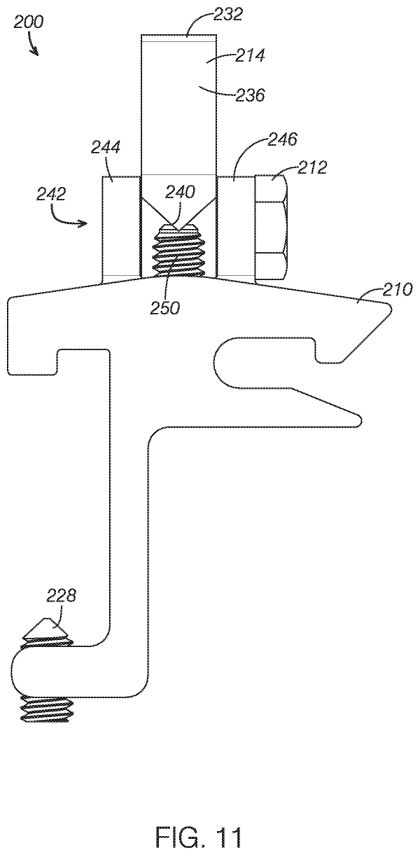

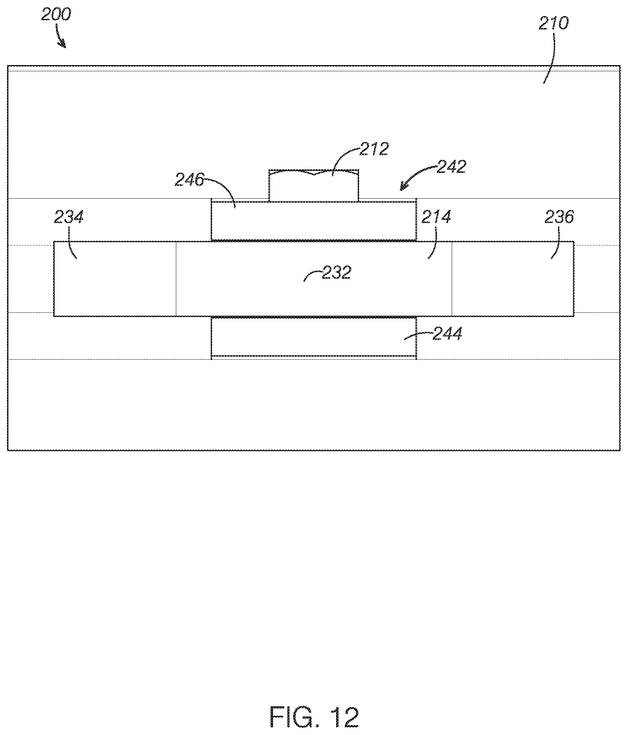

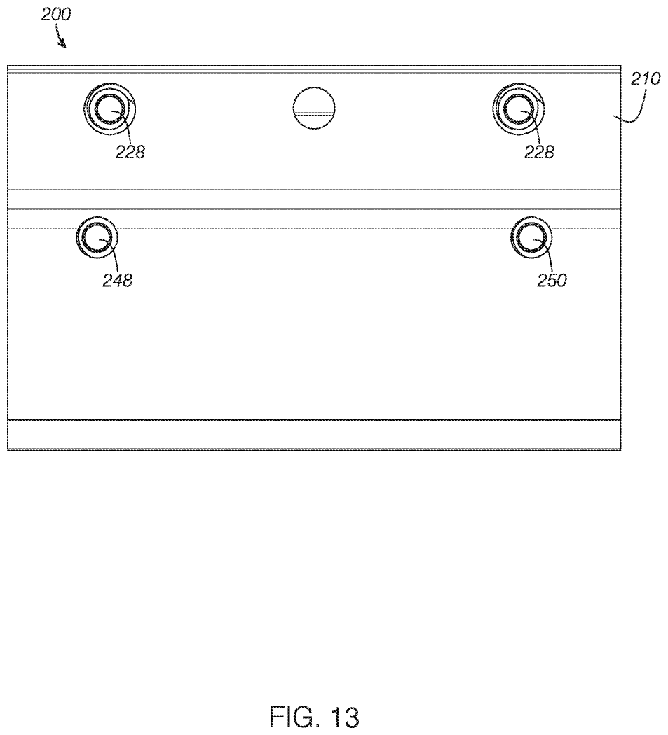

In some examples, the coupler does not include one or more features included in coupler 100. For example, some coupler examples do not include a threaded collar. In other examples, the coupler includes additional or alternative features, such as one or more rocker shafts to selectively move the arm, such as first rocker shaft 248 and second rocker shaft 250 in the coupler 200 example shown in FIGS. 8-13.

Body

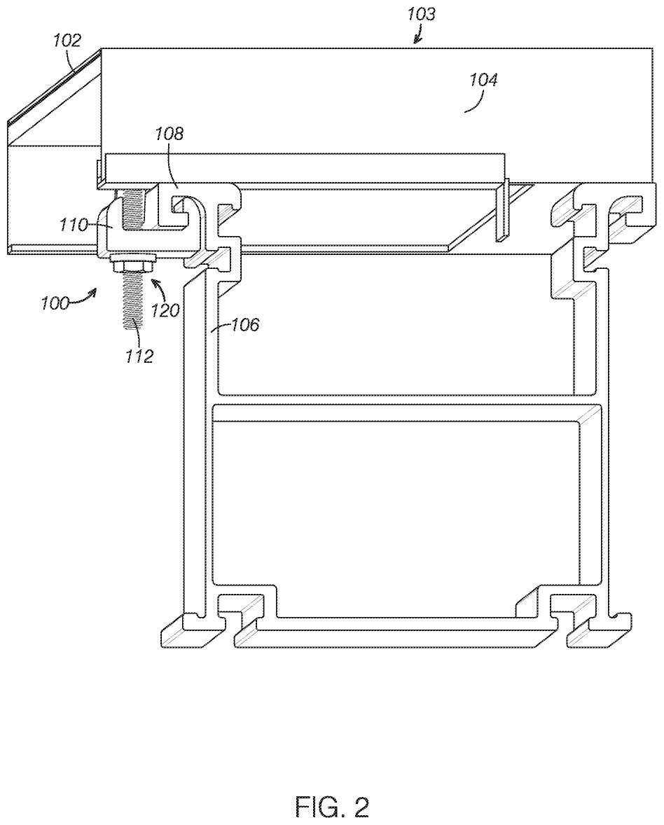

Body 110 functions to provide a mechanical platform for supporting other components of coupler 100 and to provide an electrically conductive path to rail 106. As can be seen in FIGS. 1 and 2, body 110 is complementarily configured with interface portion 108 of rail 106. The complementary configuration enables body 110 to selectively interlock with interface portion 108. Interlocking with interface portion 108 functions to mechanically and electrically couple body 110 to rail 106.

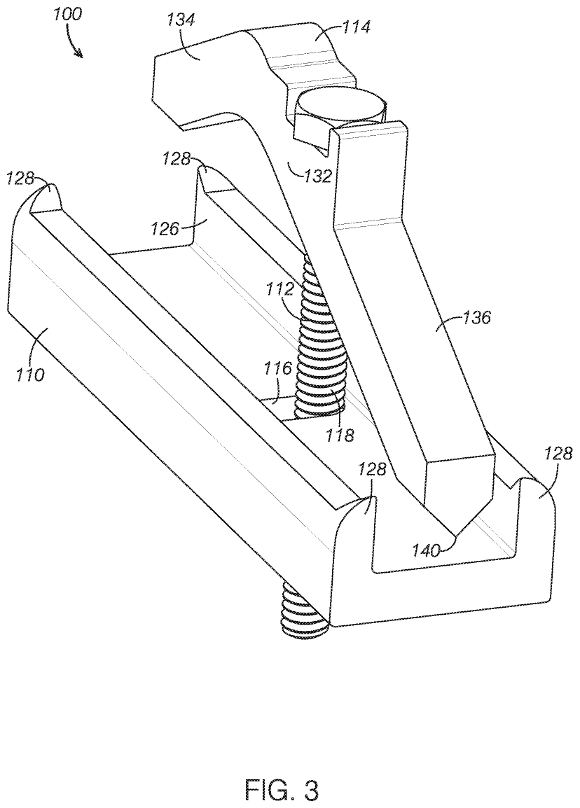

As can be seen in FIGS. 3, 6, and 7, body 110 defines a slot 116. In the coupler 100 example, as shown in FIGS. 3, 6, and 7, slot 116 extends laterally relative to body 110. In other examples, the slot extends in directions other than or in addition to laterally, such as longitudinally and/or both laterally and longitudinally. Laterally extending slot 116 enables link shaft 112 extending through slot 116 to be moved to a desired lateral position relative to body 110.

With reference to FIGS. 1-6, the reader can see that body 110 defines a channel 126. As shown in FIGS. 1 and 2, channel 126 is complementarily configured with interface portion 108 of rail 106 to receive interface portion 108.

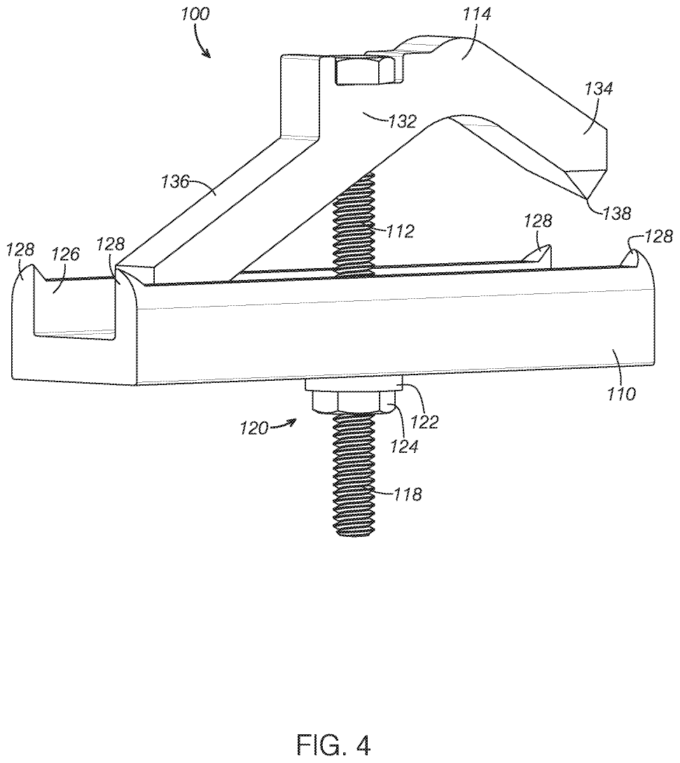

The reader can see in FIGS. 3 and 4 that body 110 defines body spikes 128 configured to puncture interface portion 108 of rail 106 to electrically couple body 110 to interface portion 108. While coupler 100 includes four body spikes 128, other coupler examples include fewer or additional body spikes. For example, some coupler examples include a single body spike, two body spikes, three body spikes, five or more body spikes. Certain coupler examples do not include body spikes and electrically couple to the rail by means other than a spike, such as contact along a face of the body or wires.

Body 110 is comprised of an electrically conductive material. In the particular example shown in FIGS. 1-7 the electrically conductive material forming the body is a metal. The electrically conductive material may be any currently known or later developed material suitable for conducting electricity and mechanically supporting components of the coupler.

In some examples, the electrically conductive material of the body is the same as the material forming other components of the coupler. In other examples, different electrically conductive materials are used for the different components of the couplers.

Link Shaft

Link shaft 112 functions to mechanically couple or link arm 114 to body 110. As shown in FIGS. 1, and 3-5, arm 114 is mounted to link shaft 112, and link shaft 112 is moveably coupled to body 110. The reader can see in FIGS. 1-7 that link shaft 112 extends through body 110 by passing through slot 116.

In the example shown in FIGS. 1-7, link shaft 112 defines a threaded bolt 118. In other examples, the link shaft is a shaft without threads, such as a dowel, pin, or peg.

Link shaft 112 is comprised of an electrically conductive material. In the particular example shown in FIGS. 1-7, the electrically conductive material forming the link shaft is a metal. The electrically conductive material may be any currently known or later developed material suitable for conducting electricity and mechanically supporting components of the coupler.

In some examples, the electrically conductive material of the link shaft is the same as the material forming other components of the coupler. in other examples, different electrically conductive materials are used for the different components of the couplers.

Arm

Arm 114 is configured to selectively but frame 104 of solar panel 102 to restrict frame 104 from moving relative to body 110. Arm 114 is further configured to electrically couple to frame 104.

As can be seen in FIGS. 1 and 3-6, arm 114 defines a torso 132, a first arm 134, and a second arm 136. Arm 114 mounts to link shaft 112 at torso 132. First arm 134 extends from torso 132 in a first direction and second arm 136 extends from torso 132 in a second direction opposite the first direction. As can be seen in FIGS. 1 and 3-5, first arm 134 of arm 114 defines an arm spike 138 and second arm 136 defines a second arm spike 140.

First arm spike 138 is configured to puncture frame 104 of solar panel 102 to electrically couple arm 114 to frame 104. Second arm spike 140 is configured to puncture body 110 to electrically couple arm 114 to body 110. In this manner, arm 114 and body 110 are in electrical communication.

Arm 114 is comprised of an electrically conductive material. In the particular example shown in FIGS. 1-7, the electrically conductive material forming the arm is a metal. The electrically conductive material may be any currently known or later developed material suitable for conducting electricity and mechanically supporting components of the coupler.

In some examples, the electrically conductive material of the arm is the same as the material forming other components of the coupler. In other examples, different electrically conductive materials are used for the different components of the couplers.

Threaded Collar

Threaded collar 120 functions to selectively restrict threaded bolt 118 from moving through slot 116 relative to body 110. Further, threaded collar 120 functions to selectively fix the lateral position of threaded bolt 118 in slot 116. As shown in FIGS. 1, 2, 4, 5, and 7, threaded collar 120 is complementarily configured with threaded bolt 118.

As shown in FIGS. 1, 2, 4, 5, and 7, threaded collar 120 includes a washer 122 and a nut 124. However, any currently known or later developed mechanical devices suitable for engaging and restricting link shaft 114 from moving may be used.

Washer 122 is configured to engage body 110. In the present example, washer 122 includes radially extending teeth to more effectively engage body 110 and to resist washer 122 moving relative to body 110.

Nut 124 is configured to threadingly couple with threaded bolt 118 and to engage washer 122. Engaging washer 122 applies compressive force on washer 122 to enable washer 122 to more tightly engage bony 110.

### Additional Embodiments

With reference to the figures not yet discussed, the discussion will now focus on additional coupler embodiments. The additional embodiments include many similar or identical features to coupler 100. Thus, for the sake of brevity, each feature of the additional embodiments below will not be redundantly explained. Rather, key distinctions between the additional embodiments and coupler 100 will be described in detail and the reader should reference the discussion above for features substantially similar between the different coupler examples.

### Second Embodiment

Turning attention to FIGS. 8-13, a second example of a coupler, coupler 200, will now be described. As can be seen in FIG. 8-13, coupler 200 includes a body 210, a link shaft 212, an arm 214, a first rocker shaft 248, and a second rocker shaft 250.

A distinction between coupler 200 and coupler 100 is that coupler 200 includes first rocker shaft 248 and second rocker shaft 250 to selectively pivot arm 214 about a bearing member 242 defined by body 210. Some coupler examples include a single rocker shaft rather than two rocker shaft as depicted in FIGS. 8-13.

Another distinction between coupler 200 and coupler 100 is that body spikes 228 are threadingly coupled to body 210 and selectively moveable relative to body 210 in contrast to fixed body spikes 128 in coupler 100. Body spikes 228 are configured to apply compressive force to rail 106 when rotated relative to body 210. The compressive force exerted by body spikes 228 functions to tightly link body 210 to rail 106 and to cause body spikes 228 to puncture rail 106 to form a more effective electrical connection.

With reference to FIGS. 8-12, the reader can see that body 210 defines a bearing member 242 having a first bearing 244 and a second bearing 246. Second bearing 246 is spaced from first bearing 244. Link shaft 212 extends from first bearing 244 to second bearing 246 and may selectively rotate relative to bearing member 242. Arm 214 is mounted to link shaft 212 and rotates relative to bearing member 242 on link shaft 212.

In the example shown in FIGS. 8-13, link shaft 212 is free to rotate relative to bearing member 242 and arm 214 is also free to rotate around link shaft 212. In some examples, the link shaft fixedly couples to the bearing member and does not rotate relative to the bearing member. In such examples, the arm rotates around link shaft fixed in place relative to the bearing members. In certain examples, the link shaft is free to rotate within the first bearing and the second bearing and the arm is fixedly mounted to the link shaft. In examples where the arm is fixedly mounted to the link shaft, the arm rotates in turn with he link shaft.

With reference to FIGS. 8-11, the reader can see that first arm 234 defines a first arm spike 238 and second arm 236 defines a second arm spike 240. First arm spike 238 and second arm spike 240 are each configured to puncture frame 104 of solar panel 102 to electrically couple arm 214 to frame 104.

As shown in FIGS. 8-11, first rocker shaft 248 is movably coupled to body 210 in position underlying first arm 234. First rocker shaft 248 is configured to extend from body 210 and rotate arm 214 relative to bearing member 242 by lifting first arm 234. In the present example, first rocker shaft 248 is threadingly coupled to body 210. The threaded coupling arrangement maintains first rocker shaft 248 in a position extended from body 210 until first rocker shaft 248 is selectively rotated to retract first rocker shaft 248 relative to body 210. Maintaining the position of first rocker shaft 248 serves to maintain the position of arm 214 as well, such as in a positron applying compressive force onto second arm spike 240.

Similarly, second rocker shaft 250 is movably coupled to body 210 in a position underlying second arm 236. Second rocker shaft 250 is configured to extend from body 210 and rotate arm 214 relative to bearing member 242 lifting second arm 236. Second rocker shaft 250 is threadingly coupled to body 210 in a manner that maintains its position extended from body 210 until it is selectively rotated to retract it relative to body 210. Maintaining the position of second rocker shaft 250 serves to maintain the position of arm 214 as well, such as in a position applying compressive force onto first arm spike 238.

In the example shown in FIGS. 8-13, arm 214 and body 210 are in electrical communication via link shaft 212. Arm 214 and body 210 are also in electrical communication via first and second rocker shafts 248 and 250. In some examples, the arm and the body are in electrical communication via additional or alternative means, such as via wires or not a the link shaft or the rocker shafts.

Summary of Operation

The components of the couplers described herein cooperate to couple a solar panel to a support rail as follows: a frame of a solar panel is held between the clamp arm and the body while the body concurrently interlocks with an interface portion of the support rail. In some examples, a nut, washer, and bolt cooperate to exert compressive force on the clamp arm as it engages the frame of the solar panel to hold the solar panel in place. The nut, washer, and bolt cooperating to exert compressive force on the clamp arm concurrently serve to tighten the interlocking engagement between the body and the interface portion of the support rail.

As compressive force is exerted by the clamp arm on the solar panel frame, a spike of the clamp arm pierces any electrically resistive or insulating layers present on the solar panel frame to establish an electrically conductive path between the solar panel frame and the coupler. The compressive force also causes one or more spikes formed on the body of the coupler to pierce resistive or insulating layers present on the support frame with which the body interlocks. The electrically conductive path thus extends from the solar panel frame through the spike in the clamp arm, through the clamp arm to the body, and through the one or more spikes of the body in contact with the support rail to the electrically conductive material of the support rail.

The disclosure above encompasses multiple distinct inventions with independent utility. While each of these inventions has been disclosed in a particular form, specific embodiments disclosed and illustrated above are not to be considered a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A coupler for mechanically and electrically coupling a solar panel mounted on a frame to a rail having an interface portion, comprising:
a body complementarily configured with the interface portion of the rail to selectively interlock with the interface portion and configured to electrically couple to the interface portion;
a link shaft moveably coupled to the body; and
an arm mounted to the link shaft and configure to selectively abut the frame of the solar panel and configured to electrically couple to the frame.

2. The coupler of claim 1, wherein:
the body defines a slot; and
the link shaft extends through the slot.

3. The coupler of claim 2, wherein:
the link shaft defines a threaded bolt; and
the coupler Further comprises a threaded collar complementarily configured with the threaded bolt to selectively restrict the threaded bolt from moving through the slot relative to the body.

4. The coupler of claim 2, wherein the slot extends laterally relative to the body.

5. The coupler of claim 4, wherein:
the link shaft defines a threaded bolt; and
the coupler farther comprises a threaded collar complementarily configured with the threaded bolt to selectively restrict the threaded bolt from moving through the slot relative to the body and to selectively fix the lateral position of the threaded bolt in the slot.

6. The coupler of claim 1, wherein the threaded collar includes:
a washer configured to engage the body; and
a nut configured to engage the washer.

7. The coupler of claim 1, wherein the body defines a channel complementarily configured with the interface portion of the rail to receive the interface portion.

8. The coupler of claim 1, wherein the body defines a body spike configured to puncture the interface portion of the rail to electrically couple the body to the interface portion.

9. The coupler of claim 1, wherein the arm defines an arm spike configured to puncture the frame of the solar panel to electrically couple the arm to the frame.

10. The coupler of claim 1, wherein:
the arm defines;
a torso;
a first arm extending from the torso; and
a second arm extending from the torso opposite the first arm;
the arm mounts the link shaft at the torso.

11. The coupler of claim 10, wherein:
the first arm defines a first arm spike configured to puncture the frame of the solar panel to electrically couple the arras to the frame; and
the second arm defines a second arm spike configured to puncture the frame of the solar panel to electrically couple the arm to the frame.

12. The coupler of claim 10, wherein;
the body defines a bearing member having a first bearing and a second bearing spaced from the first bearing; and
the link shaft extends from the first bearing to the second bearing and may selectively rotate relative to the bearing member.

13. The coupler of claim 12, further comprising a first rocker shaft movably coupled to the body in a position underlying the first arm, wherein the first rocker shaft is configured to extend from the body and rotate the arm relative to the bearing member by lifting the first arm.

14. The coupler of claim 13, further comprising a second rocker shaft movably coupled to the body in a position underlying the second arm, wherein the second rocker shaft is configured to extend from the body and rotate the arm relative to the bearing member by lifting the second arm.

15. The coupler of claim 13, wherein the first rocker shaft is threadingly coupled to the body.

16. The coupler of claim 15, wherein the first rocker shaft and the body are threadingly coupled in a manner that maintains the first ocker shaft in a position extended from the body until the first rocker shaft is selectively rotated to retract the first rocker shaft relative to the body.

17. The coupler of claim 1, wherein:
the arm is comprised of a first electrically conductive material; and
the body is comprised of a second electrically conductive material.

18. The coupler of claim 17, wherein the arm and the body are in electrical communication.

19. The coupler of claim 18, wherein:
the link shaft is comprised of third electrically conductive material; and
the arm and the body are in electrical communication via the link shaft.

20. A coupler for mechanically and electrically coupling a solar panel mounted on a frame to a rail having an interface portion, comprising:
a body comprised of a first electrically conductive material and complementarily configured with the interface portion of the rail to selectively interlock with the interface portion and configured to electrically couple to the interface portion, the body defining:
a channel complementarily configured with the interface portion of the rail to receive the interface portion; and
a body spike configured to puncture the interface portion of the rail to electrically couple the body to the interface portion;
a link shaft moveably coupled to the body; and
an arm:
comprised of a second electrically conductive material;
in electrical communication with the body;
mounted to the link shaft; and
configured to selectively abut the frame of the solar panel and configured to electrically couple to the frame;
wherein the arm defines:
a torso mounted to the link shaft;
a first arm extending from the torso;
a second arm extending from the torso opposite the first arm;
a first arm spike extending from the first arm and configured to puncture the frame of the solar panel to electrically couple the arm to the frame; and
a second arm spike extending from the second arm and configured to puncture the frame of the solar panel to electrically couple the arm to the frame.
